(19) United States
(12) Patent Application Publication
(10) Pub. No.: US 2018/0017085 A1
(43) Pub. Date: Jan. 18, 2018

(54) FAN BLADE COVER SYSTEM

(71) Applicant: Timothy E. Rivera, Ocala, FL (US)

(72) Inventor: Timothy E. Rivera, Ocala, FL (US)

(21) Appl. No.: 15/207,760

(22) Filed: Jul. 12, 2016

(51) Int. Cl. F04D 29/70; F04D 29/02; F04D 25/08; F04D 29/38

(52) U.S. Cl. CPC F04D 29/703; F04D 29/388; F04D 29/023; F04D 25/088; F05B 2230/60; F05B 2280/60

(57) ABSTRACT

A fan blade cover system that includes: a sleeve adapted to slide onto a fan blade; an opening at one end of the sleeve, where the opening enables the placement of the sleeve over the fan blade; and a fragrance embedded within the sleeve. The fan blade system creates a method of fan blade protection and room deodorizing that includes the steps of: configuring a sleeve for placement over a fan blade; embedding a fragrance embedded into the sleeve; and sliding the sleeve over the fan blade.

### BACKGROUND OF THE INVENTION

### Field of Invention

The present invention relates to system to cover ceiling fan blades.

### Description of Related Art

A ceiling fan is a common appliance with both in commercial and residential applications. Ceiling fans help to circulate the air within a room for cooling or warming purposes. Principally, the ceiling fan circulates air to an otherwise stagnant room. One drawback to ceiling fans is the accumulation of dirt and dust on the fan blades. As a result, the fan blades must be cleaned periodically to remove the accumulated dust and debris. It would therefore be advantageous to have a system, where the fan blades were covered and able to be protected from dust accumulation.

### SUMMARY OF THE INVENTION

The present invention relates to a fan blade cover system that includes: a sleeve adapted to slide onto a fan blade; an opening at one end of the sleeve, where the opening enables the placement of the sleeve over the fan blade; and a fragrance embedded within the sleeve. The fan blade system creates a method of fan blade protection and room deodorizing that includes the steps of: configuring a sleeve for placement over a fan blade; embedding a fragrance embedded into the sleeve; and sliding the sleeve over the fan blade.

### BRIEF DESCRIPTION OF DRAWINGS

FIG. 1 depicts a fan blade partially covered with a sleeve in accordance with the present invention.

FIG. 2 depicts a fully covered fan blade using the sleeve in accordance with the present invention.

### DETAILED DESCRIPTION

The present invention relates to fan blade cover used to cover an operating fan blade of a ceiling fan according to present invention used in the form of a sleeve that securely fits over the fan blade. This sleeve helps keep dust from accumulating on the fan blade and preferably it's made of a scented stretchable fabric. As a result, the sleeve functions in both protecting a fan blade and deodorizing the room due to the scent provided on the sleeve.

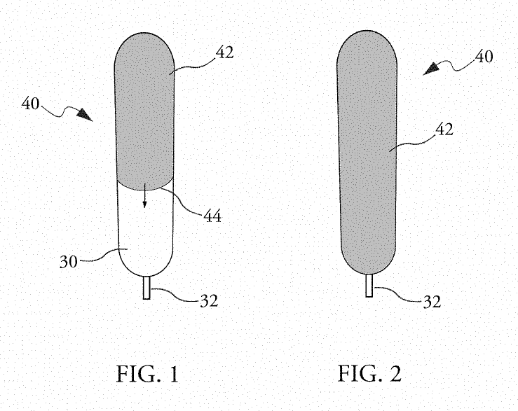

The present invention is effectively used for both collecting dust and deodorizing a room. In referenced to FIG. 1, a fan blade cover system 40 that includes a sleeve 42 sliding onto a fan blade 30. This fan blade cover system 40 simply slides over the fan blade 30 as shown an opening 44 is provided on one portion of the sleeve 42, which slides to cover the entire fan blade 30 as shown in FIG. 2. A stem 32, partially shown, extends from the fan blade 30. During use, a user places the sleeve 40 onto the fan blade 30 and helps to protect the fan blade 30 from dust accumulation, but also functions to deodorize the room when the ceiling fan is in operation. The instant invention has been shown and described in what it considers to be the most practical and preferred embodiments. It is recognized, however, that departures may be made there from within the scope of the invention and that obvious modifications will occur to a person skilled in the art.

What is claimed is:

1. A fan blade cover system comprising:
a. a sleeve adapted to slide onto a fan blade;
b. an opening at one end of the sleeve, where the opening enables the placement of the sleeve over the fan blade; and
c. fragrance embedded within the sleeve.

2. A method of fan blade protection comprising the steps of:
a. configuring a sleeve for placement over a fan blade;
b. embedding a fragrance into the sleeve; and
c. sliding the sleeve over the fan blade.

3. A method of room of deodorizing comprising the steps of:
a. configuring a sleeve for placement over a fan blade;
b. embedding a fragrance into the sleeve; and
c. sliding the sleeve over the fan blade.
